(19) United States
(12) Patent Application Publication
(10) Pub. No.: US 2012/0105584 A1
(43) Pub. Date: May 3, 2012

(54) CAMERA WITH SENSORS HAVING DIFFERENT COLOR PATTERNS

(76) Inventors: Andrew C. Gallagher, Fairport, NY (US); Amit Singhal, Pittsford, NY (US)

(21) Appl. No.: 12/913,819

(22) Filed: Oct. 28, 2010

(51) Int. Cl. H04N 13/02

(52) U.S. Cl. 348/46; 348/E13.074

(57) ABSTRACT

An image capture device includes a lens arrangement having a first lens associated with a first digital image sensor and a second lens associated with a second digital image sensor; the first digital image sensor having photosites of a first predetermined color pattern for producing a first digital image; the second digital image sensor having photosites of a different second predetermined color pattern for producing a second digital image. The image capture device also includes a device for causing the lens arrangement to capture a first digital image from the first digital image sensor and a second digital image from the second digital image sensor at substantially the same time; a processor aligning the first and second digital images; and the processor using values of the second image based on the alignment between the first and second images operates on the first digital image to produce the enhanced digital image.

### CROSS REFERENCE TO RELATED APPLICATION

Reference is made to commonly assigned U.S. patent application Ser. No. ______ filed concurrently herewith, entitled “Combining Images Captured With Different Color Patterns” by Amit Singhal et al, the disclosure of which is incorporated herein.

### FIELD OF THE INVENTION

The present invention relates to a camera that includes two sensors, each with its own color pattern. A processor in the image capture device produces an enhanced image using pixel values from an image from each sensor.

### BACKGROUND OF THE INVENTION

Stereo and multi-view imaging has a long and rich history stretching back to the early days of photography. Stereo cameras employ multiple lenses to capture two images, typically from points of view that are horizontally displaced, to represent the scene from two different points of view. The multiple images that result are displayed to a human viewer, to let the viewer experience an impression of 3D. The human visual system then merges information from the pair of different images to achieve the impression of depth.

Stereo cameras can come in any number of configurations. For example, a lens and a sensor unit are attached to a port on a traditional single-view digital camera to enable the camera to capture two images from slightly different points of view, as described in U.S. Pat. No. 7,102,686. In this configuration, the lenses and sensors of each unit are similar and enable the interchangeability of parts. Other cameras contain two or more lenses are described, such as in U.S. Patent Application Publication 2008/0218611, where a camera has two lenses and sensors and an improved image (with respect to sharpness, for example) is produced.

In another line of teaching, U.S. Pat. No. 6,476,865 describes an image sensing device containing both color and luminance photosites. The color photosites are covered with a transmissive color filter, such as red, green or blue which permit light energy from only a certain range of the visible spectrum to pass. This arrangement has the advantage of improved dynamic range because the luminance photosites have a desirable performance in low light situations, and the color photosites, which accumulate fewer photons in the same light exposure than the luminance photosites, have the desirable property that they do not clip, and have desirable performance in situations with more abundant light. In U.S. Pat. No. 6,373,523, a single-lens CCD camera with two CCDs having mutually different color filter arrays is described. A prism beam splitter is used to split the image into different colors that physically are read by two different color sensor patterns.

Further, there exist in the art many methods for image colorization. Colorization refers to the process of adding chrominance values to grayscale images. Existing methods of color image enhancement have focused upon transferring the “color mood” from one image to another. In these cases, the actual contents of the image can vary greatly between the images, and the images are not simultaneously presented to a viewer. In U.S. Pat. No. 4,984,072, a method of color enhancing regions in images having similar desired hues is described, in which color lookup tables are used in order to convert gray-scale values into unique values of hue, luminance and saturation. This method yields a one-to-one mapping within a region for each gray-scale value as the color lookup table is predetermined by the mapping of a gray-scale value in a region to a hue, luminance and saturation value. The color lookup table is generated from a similar image, resulting in similar colors being applied to the grayscale image. However, it does not enforce any spatial correspondence between the two images, resulting in images with potentially different color values for the same pixel in both images if applied to a stereo pair.

### SUMMARY OF THE INVENTION

In accordance with the present invention, there is provided an image capture device for producing an enhanced digital image of a scene comprising:

(a) a lens arrangement having a first lens associated with a first digital image sensor and a second lens associated with a second digital image sensor; the first digital image sensor having photosites of a first predetermined color pattern for producing a first digital image of the scene; the second digital image sensor having photosites of a different second predetermined color pattern for producing a second digital image of the scene;

(b) a device for causing the lens arrangement to capture a first digital image from the first digital image sensor and a second digital image from the second digital image sensor at substantially the same time;

(c) a processor for aligning the first and second digital images; and

(d) the processor using values of the second image based on the alignment between the first and second images to operate on the first digital image to produce the enhanced digital image having corrected color values.

An advantage of the present invention is that it provides an effective way for capturing multiple views of a scene with high dynamic range and low noise by using different predetermined color filter patterns.

### BRIEF DESCRIPTION OF THE DRAWINGS

FIG. 1 is a block diagram of an image capture device with multiple image sensors and processors of the present invention;

FIG. 2 is an illustration of an image capture device shown as a camera in accordance with the present invention;

FIG. 3 is an illustration of another camera in accordance with the present invention;

FIG. 4 is an illustration of a still another camera in accordance with the present invention;

FIG. 5 is an illustration of yet another camera in accordance with the present invention;

FIG. 6 is an illustration of photosites of a pair of image sensors;

FIG. 7 is an illustration of different photosites with the pair of image sensors;

FIG. 8 is an illustration of still another set of photosites with the pair of image sensors;

FIG. 9 is an illustration of yet another set of photosites with the pair of image sensors;

FIG. 10 is an illustration of still another set of photosites with the pair of image sensors;

FIG. 11 is an illustration of a method to produce an enhanced image in accordance with the present invention;

FIG. 12 is an illustration of the feature point matches between a pair of images;

FIG. 13 is an illustration of the photosites of FIG. 6 but in an overlapping relationship; and

FIG. 14 uses the method of FIG. 11 to produce a pair of enhanced images.

### DETAILED DESCRIPTION OF THE INVENTION

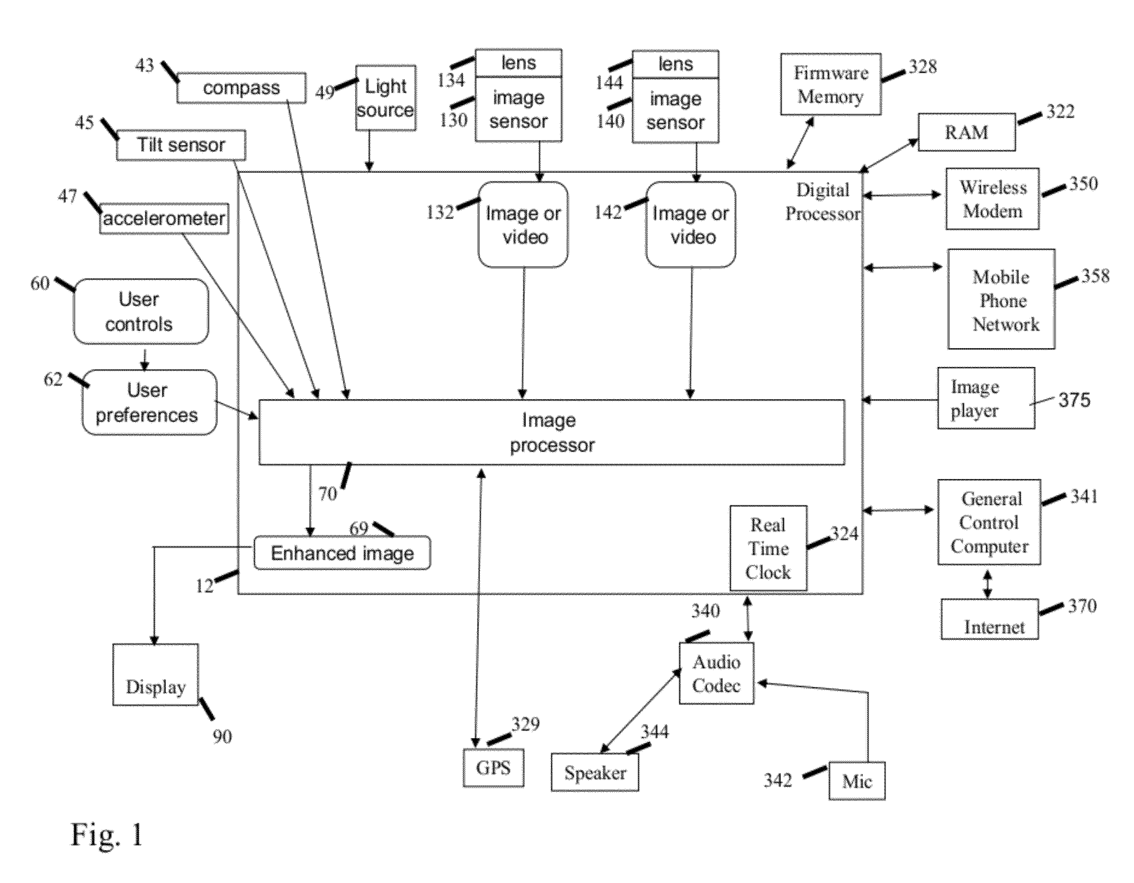

FIG. 1 is a block diagram of an image capture device 30 and processing system that are used to implement the present invention. The present invention can also be implemented for use with any type of digital image capture device, such as a digital still camera, camera phone, personal computer, or digital video cameras, or with any system that receives digital images. As such, the invention includes methods and apparatus for both still images and videos. The present invention describes a system that uses at least two image sensors 130 and 140, each with a respective lens 134 and 144, for capturing a pair of images or videos 132 and 142 at substantially the same time, for example, less than a half second of each other. In other embodiments of the present invention, there are more than two image sensors 130, 140, lenses 134 and 144, and resulting images and videos 132 and 142. The image sensors 130, 140 and the lenses 134, 144, considered together, are a stereo lens arrangement having a first lens 134 associated with a first digital image sensor 130 and a second lens 144 associated with a second digital image sensor 140. Capturing multiple views of a scene from different perspectives enables the multiple images that result to be displayed to a human viewer. The viewer experiences an impression of the 3D geometry of the scene when each eye views an image captured from a slightly different position in the scene.

For convenience of reference, it should be understood that the image or video 132, 142 refers to both still images and videos or collections of images. Further, the images or videos 132, 142 are images that are captured with image sensors 130, 140. The images or videos 132, 142 can also have an associated audio signal. The system of FIG. 1 contains a display 90 for viewing images. The display 90 includes monitors such as LCD, CRT, OLED or plasma monitors, and monitors that project images onto a screen. The sensor arrays of the image sensors 130, 140 can have, for example, 1280 columns×960 rows of pixels. When advisable, the image sensors 130, 140 activate a light source 49, such as a flash, for improved photographic quality in low light conditions.

In some embodiments, the image sensors 130, 140 can also capture and cause a video clip to be stored. The digital data is stored in a RAM buffer memory 322 and subsequently processed by a digital processor 12 controlled by the firmware stored in firmware memory 328, which is flash EPROM memory. The digital processor 12 includes a real-time clock 324, which keeps the date and time even when the system and digital processor 12 are in their low power state.

The digital processor 12 operates on or provides various image sizes selected by the user or by the system. Images are typically stored as rendered sRGB image data is then JPEG compressed and stored as a JPEG image file in the memory. The JPEG image file will typically use the well-known EXIF (EXchangable Image File Format) image format. This format includes an EXIF application segment that stores particular image metadata using various TIFF tags. Separate TIFF tags are used, for example, to store the date and time the picture was captured, the lens F/# and other camera settings for the image capture device 30, and to store image captions. In particular, the ImageDescription tag is used to store labels. The real-time clock 324 provides a capture date/time value, which is stored as date/time metadata in each EXIF image file. Videos are typically compressed with H.264 and encoded as MPEG4.

In some embodiments, the geographic location is stored with an image captured by the image sensors 130, 140 by using, for example a GPS unit 329. Other methods for determining location can use any of a number of methods for determining the location of the image. For example, the geographic location is determined from the location of nearby cell phone towers or by receiving communications from the well-known Global Positioning Satellites (GPS). The location is preferably stored in units of latitude and longitude. Geographic location from the GPS unit 329 is used in some embodiments to regional preferences or behaviors of the display system.

The graphical user interface displayed on the display 90 is controlled by user controls 60. The user controls 60 can include dedicated push buttons (e.g. a telephone keypad) to dial a phone number; a control to set the mode, a joystick controller that includes 4-way control (up, down, left, and right) and a push-button center “OK” switch, or the like. The user controls 60 are used by a user to indicate user preferences 62 or to select the mode of operation or settings for the digital processor 12 and image capture devices 130, 140.

The display system can in some embodiments access a wireless modem 350 and the internet 370 to access images for display. The display system is controlled with a general control computer 341. In some embodiments, the system accesses a mobile phone network 358 for permitting human communication via the system, or for permitting signals to travel to or from the display system. An audio codec 340 connected to the digital processor 12 receives an audio signal from a microphone 342 and provides an audio signal to a speaker 344. These components are used both for telephone conversations and to record and playback an audio track, along with a video sequence or still image. The speaker 344 can also be used to inform the user of an incoming phone call. This is done using a standard ring tone stored in firmware memory 328, or by using a custom ring-tone downloaded from the mobile phone network 358 and stored in the memory 322. In addition, a vibration device (not shown) is used to provide a quiet (e.g. non audible) notification of an incoming phone call.

The interface between the display system and the general purpose computer 341 is a wireless interface, such as the well-known Bluetooth® wireless interface or the well-known 802.11b wireless interface. The images or videos 132, 142 are received by the display system via an image player 375 such as a DVD player, a network, with a wired or wireless connection, via the mobile phone network 358, or via the internet 370. It should also be noted that the present invention is implemented in a combination of software and hardware and is not limited to devices that are physically connected or located within the same physical location. The digital processor 12 is coupled to a wireless modem 350, which enables the display system to transmit and receive information via an RF channel 250. The wireless modem 350 communicates over a radio frequency (e.g. wireless) link with the mobile phone network 358, such as a 3GSM network. The mobile phone network 358 can communicate with a photo service provider, which can store images. These images are accessed via the Internet 370 by other devices, including the general purpose computer 341. The mobile phone network 358 also connects to a standard telephone network (not shown) in order to provide normal telephone service.

Referring again to FIG. 1 the digital processor 12 accesses a set of sensors including a compass 43 (preferably a digital compass), a tilt sensor 45, the GPS unit 329, and an accelerometer 47. Preferably, the accelerometer 47 detects both linear and rotational accelerations for each of three orthogonal directions (for a total of 6 dimensions of input). This information is used to improve the quality of the images using an image processor 70 (by, for example, deconvolution) to produce an enhanced image 69, or the information from the sensors is stored as metadata in association with the image. In the preferred embodiment, all of these sensing devices are present, but in some embodiments, one or more of the sensors is absent.

Further, the image processor 70 is applied to the images or videos 132, 142 based on user preferences 62 to produce the enhanced image 69 that is shown on the display 90. The image processor 70 improves the quality of the original images or videos 132, 142 by, for example, removing the hand tremor from a video.

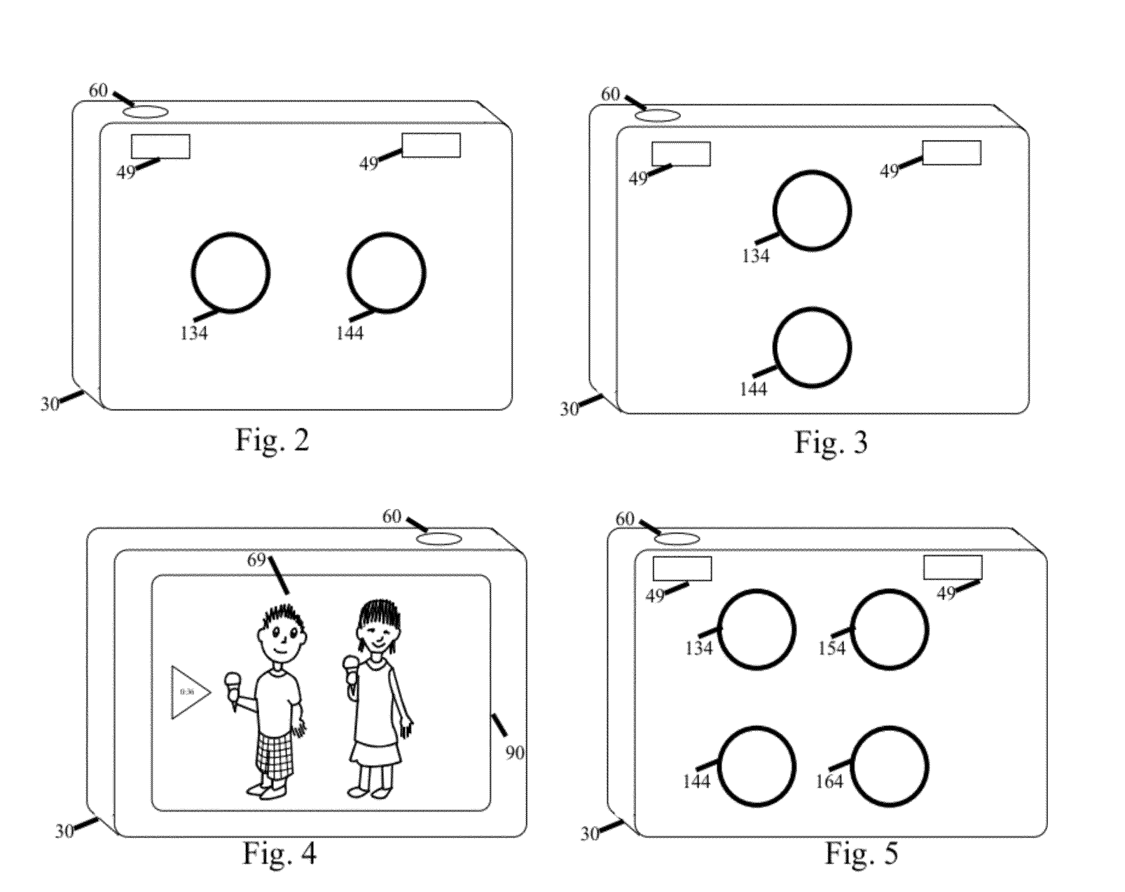

FIGS. 2-5 show the image capture device as a physical object to illustrate different configurations of the parts. FIG. 2 shows the image capture device having lenses 134 and 144 that are horizontally displaced, as is typical with stereo or multiview image and video capture. The image capture device contains integral light sources 49 to illuminate an otherwise dark scene. Light sources 49 can also be used to project patterns on a scene that are useful for recovering the 3D structure and object shapes of objects in the scene. A user control 60, in this arrangement a device such as button, is used by the human to initiate the capture of an image or video by both image sensors (130 and 140 of FIG. 1) at substantially the same time. The user control 60 is a mechanically depressible button, or it is a virtual device such as a button on a graphical user interface or display with a touch screen.

FIG. 3 shows an alternative arrangement of the lenses 134 and 144 on the image capture device. In this arrangement the lenses have vertical displacement. This configuration is useful for capturing a scene at vertical positions that are displaced.

FIG. 4 shows the image capture device from the display 90 side. The display 90 is a standard LCD or OLED display as is well known in the art, or it is a stereo display such as described in U.S. Ser. No. 12/705,652 filed Feb. 15, 2010, entitled “3-Dimensional Display With Preferences”. In FIG. 4, the display 90 displays the enhanced image 69 that is a video. The display 90 preferably contains a touch-screen interface that permits a user to control the device, for example, by playing the video when the triangle is touched.

FIG. 5 shows yet another illustrative configuration of the image capture device where the image capture device contains four lenses 134, 144, 154, 164 arranged on the front of the device. Although FIGS. 2-5 show all lenses of the image capture device as being part of a single unit, that is not necessarily the case. In alternative configurations, each lens 134 and associated image sensor 130 is packaged separately as for example is taught in U.S. Pat. No. 7,102,686. Then, multiple packages can either be snapped together as building blocks to permit control of all image sensors from a user interface, or each package uses communication (e.g. the mobile phone network 358 of FIG. 1) to provide control.

The inventive image capture device has associated with it two or more image sensors that capture images 132, 142 at substantially the same time. The image processor 70 combines those images 132, 142 to produce the enhanced image 69.

In one embodiment, the image sensors 130, 140 each contain a different predetermined color pattern. As is well known, image sensors contain photosites arranged on a regular grid. Typically, a photosite is covered with a filter such as a red filter, a green filter, a blue filter, or a yellow filter that permits transmittance of certain wavelengths of light to enter the photosite. Note that having a photosite with no filter permits it to be sensitive to all wavelengths of light and is called a “luminance” photosite. In some cases, a luminance photosite is covered with a filter to prevent infrared sensitivity while permitting the photosite to maintain sensitivity to the visible spectrum. To produce a full color image where each pixel location has associated with it information about the intensity of light for a set of color primaries of light (typically red, green and blue); an algorithm called demosaicing (or color filter array interpolation) is applied. The predetermined color pattern typically contains a repeating color unit that repeats over the image sensor. For example, the common Bayer Filter Array has a 2×2 color unit containing two green photosites, one red photosite, and one blue photosite. The color pattern of the image sensors 130, 140 is typically fixed at the time of manufacture, and does not change (and is therefore predetermined). The predetermined color pattern is represented by the repeating color unit and its positions within the image sensor such that this repeating color unit is used to tile in a non-overlapping fashion over the image sensor. The same repeating color unit placed in different positions within different image sensors can produce image sensors with different predetermined color patterns. Some image sensors 130, 140 have a small repeating color unit such as the 2×2 Bayer pattern and the 2×2 pattern (red green blue and luminance) of U.S. Pat. No. 6,476,865. Other predetermined color patterns, such as that described in U.S. Pat. No. 6,909,461, have a larger repeating color unit of 2×4 pixels or 4×4 pixels.

In one embodiment, the enhanced image 69 is produced by combining information from two or more of the images 132, 142 captured by different image sensors 130, 140. In another embodiment, the enhanced image 69 is a full color image produced using information from two or more images 132 142, wherein each of the images 132 and 142 are single color images where each pixel location is associated with only a single value corresponding to the intensity of light for a certain spectral description (the value of which is related to the transmittance of the color filter array and other factors, such as the sensitivity of the photosite to different wavelengths of light).

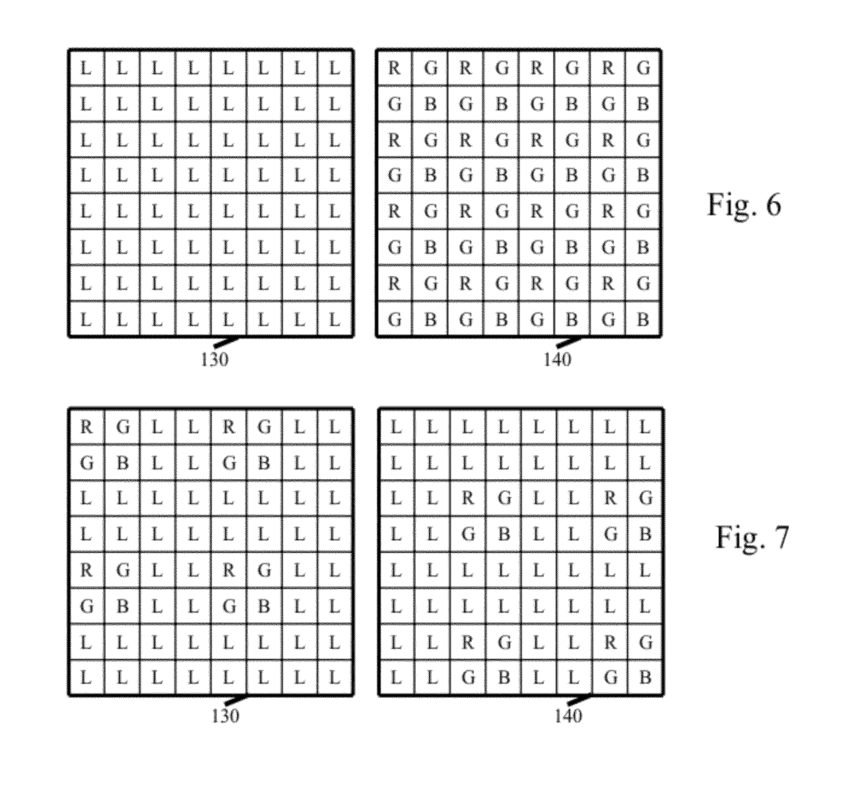

FIG. 6 shows predetermined color patterns for two image sensors 130, 140 that are used in an embodiment of the present invention. In this embodiment, the image sensor 130 has a predetermined color pattern that contains a single repeating unit “L” indicating a luminance photosite that is substantially equally sensitive to all wavelengths of light energy. On the other hand, the image sensor 140 contains the 2×2 repeating element of the Bayer filter array and contains two green sensitive photosites, one red sensitive photosite and one blue sensitive photosite. Not only to the two image sensors 130, 140 have different predetermined color patterns, but they also contain photosites sensitive to different sets of colors. That is, the color filters on the second image sensor 140 (red, green and blue) do not appear on the first image sensor 130.

Each of the image sensors 130 and 140 produce a single channel digital image (the image or video 132 and 142, respectively). In this scenario, it is important to notice that the image captured with the image sensor 130 has improved signal to noise ratio because each photosite is sensitive to all wavelengths of light. However, the image from image sensor 130 does not naturally contain color information. On the other hand, the image or video 142 from the image sensor 140 has inferior signal to noise ratio (due to the fact that some quantity of the light energy never reached the sensitized portion of the photosites because of the color filters, but nevertheless, the image 142 does contain color information.

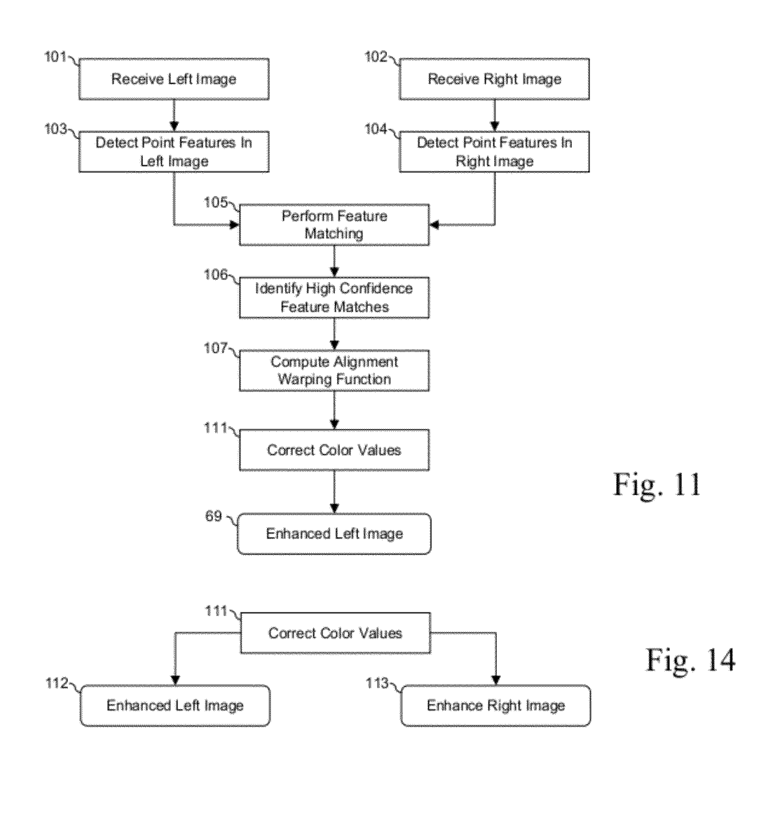

The image processor 70 inputs both images 132 and 142 and combines information from both images to produce an enhanced image 69. The method implemented by the image processor 70 to produce the enhanced image 69 is illustrated in FIG. 11. For purposes of illustration, the image 132 is referred to as the left image, and the image 142 is referred to as the right image, based on the configuration of the image sensors 130 and 140 on the image capture device.

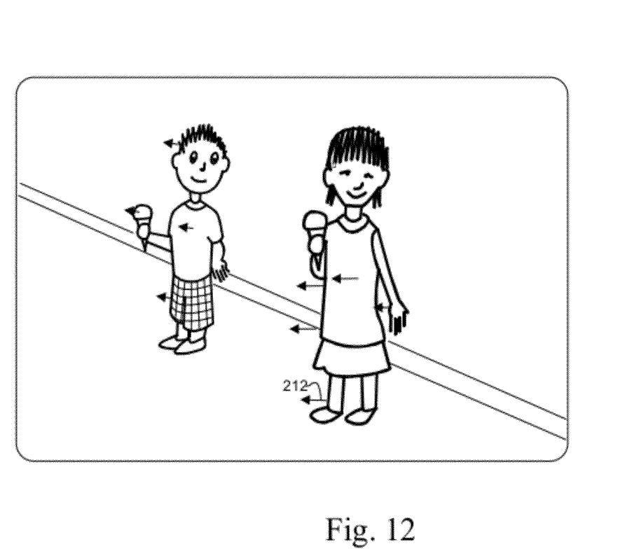

In step 101, the left image is received by the image processor 70, and in 102, the right image is received by the image processor 70. In step 103, the image processor detects point features in the left image, and in step 104, the image processor detects point features in the right image. The point features, often called feature points, are distinctive patterns of lightness and darkness that are identified across views of an object. Preferably, the method U.S. Pat. No. 6,711,293 is used to identify feature points called SIFT features, although other feature point detectors and feature point descriptions are used. Next, in step 105, the features are matched across the images to establish a correspondence between feature point locations in the left image and the right image. This matching process is also described in U.S. Pat. No. 6,711,293. Next, in step 106, the image processor 70 identifies high confidence feature point matches. Step 106 is performed by, for example, removing feature point matches that are weak (where the SIFT descriptors between putative matches are less similar than a predetermined threshold), or by enforcing geometric consistency between the matching points, as, for example, is described in Josef Sivic, Andrew Zisserman: Video Google: A Text Retrieval Approach to Object Matching in Videos. ICCV 2003: 1470-147. An illustration of the identified feature point matches is shown in FIG. 12 for an example image. A vector 212 indicates the spatial relationship between a feature point in the left image to the matching feature point in the right image. In the example, the vectors 212 are overlaid on the left image, and the right image is now shown.

Next, in step 107, the image processor 70 computes an alignment warping function that warps the positions of feature points from one image to be more similar to the corresponding positions of the matching feature points. Essentially, the alignment warping function is able to warp one image (e.g. the right image) in a manner so that objects in the warped version of that image are at roughly the same position as the corresponding objects in the other image (e.g. the right image). The alignment warping function is any of several functions. In one embodiment, the alignment warping function is a linear transformation of coordinate positions. In a general sense, the warping alignment function maps pixel locations from one image to pixel locations into a second image. In many cases an alignment warping function is invertible, so that the alignment warping function also (after inversion) maps pixel locations in the second image to pixel locations in the first image. The alignment warping function is any of several types of warping functions known in the art, such as: translational warping (2 parameters), affine warping (6 parameters), perspective warping (8 parameters), and polynomial warping (number of parameters depend on the polynomial degree) or warping over triangulations (variable number of parameters). In this step, an alignment of the first and second digital images is found.

In equation form, let A be the alignment warping function. Then A(x,y)=(m,n) where (x,y) is a pixel location in the first image, and (m,n) is a pixel location in the second image. Then, (x,y)=A⁻¹ (m,n). The alignment warping function typically has a number of free parameters, and values for these parameters are determined with well-known methods (such as least square methods) by using the set of high confidence feature matches from the first and the second images. Other alignment warping functions exist in algorithmic form to map a pixel location (x,y) in the first image to the second image, such as, find the nearest feature point in the first image that has a corresponding match in the second image. In the first image, this feature point has pixel location (Xᵢ, Yᵢ) and corresponds to the feature point in the second image with location (Mᵢ, Nᵢ). Then, the pixel at position (x,y) in the first image is determined to map to the position (x-Xᵢ+Mᵢ, y-Yᵢ+Nᵢ) in the second image.

Once the alignment warping function A is determined, the image processor 70 performs step 111 to produce corrected color values, producing the enhanced image 69. The enhanced image 69 contains, at each pixel location, a value for each of a set of at least three color primaries (typically, a red, green and blue light intensity value for each pixel location (m,n)). The step 111 correct color values uses information from both the left and the right images, which each have only one channel of pixel values, and the pixel value at a given location corresponds to a particular color filter, to produce a multichannel image (the enhanced image 69) where each pixel location contains a value for a set of at least three color primaries.

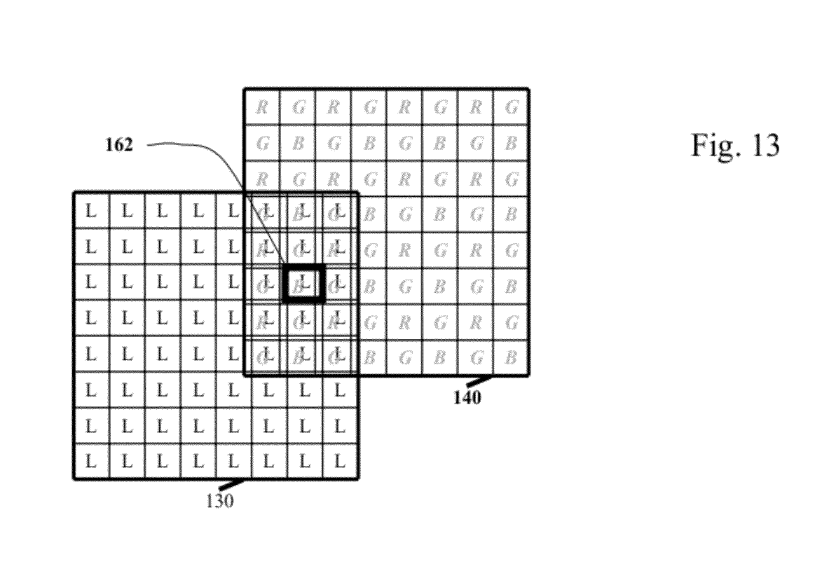

Step 111 proceeds by determining the missing color values at a pixel location in a first image by using pixel values from both the first image, and from regions of the second image that, when the alignment warping function A is applied, are spatially close to the pixel location in the first image. For example, consider FIG. 13, which shows a portion of a first image sensor 130 having all luminance photosites (L) and a portion of a second image sensor 140 having red, green and blue photosites (as originally shown in FIG. 6). The sensors are shown overlapped to illustrate the affect of applying the alignment warping function A to the second image sensor 140 to bring it into alignment with the first image sensor coordinate system. In step 111, the missing color values are determined for a pixel location 162 at location (7,3) in the first image sensor 130, which maps to location (2,6) in the second image sensor 140. Then, the missing color values at position (7,3) are found using interpolation from pixel values from both the first and second images from the image sensors 130, 140. For notation, the missing red, green and blue values at position (x,y) in the first image are indicated as r₁(x,y), g₁ (x,y) and b₁(x,y), respectively. Likewise, the notation b2 (2,6) indicates the value associated with a blue filter in the second image at position (2,6). These missing values are determined with any of a number of interpolation algorithms, for example:

L₂(2,6)=[g₂(2,5)+g₂(1,6)+g₂(1,6)+g₂(2,7)]/12+[r₂(1,5)+r₂(1,7)+r₂(3,5)+r₂(3,7)]/12+b₂(2,6)/3

r₁(7,3)=L₁(7,3)+[r₂(1,5)+r₂(1,7)+r₂(3,5)+r₂(3,7)]/4−L₂(2,6)

g₁(7,3)=L₁(7,3)+[g₂(2,5)+g₂(1,6)+g₂(1,6)+g₂(2,7)]/4−L₂(2,6)

b₁(7,3)=L₁(7,3)+b₂(2,6)−L₂(2,6)

Similar equations are constructed to determine missing color values for other locations in the first image.

In another embodiment, the image processor 70 produces two enhanced images for each of the number of image sensors 130 that are present on the image capture device. For example, if the image capture device contains a left image sensor 130 and a right image sensor 140 and captures a left image 132 and a right image 142, then the image processor 70 produces two enhanced images 112, 113 (corresponding to enhanced image 69 of FIG. 1), one for the left and one for the right image sensor. Referring to FIG. 14, the step 111 of correct color values produces enhanced images 112 and 113 using the method described previously for producing enhanced image 69. FIG. 14 illustrates that the image processor 70 produces an enhanced left image 112 and an enhanced right image 113. In the preferred embodiment, these two images, taken together, are a pair of views of a scene that can then undergo further processing in the image processor to package them for stereo viewing. For example, an anaglyph image is created from the pair for viewing with anaglyph glasses, or the pair of images is displayed on a display 90 that is capable of stereo or 3D display, such as with polarized glasses or shutter glasses. In this way, the image processor 70 uses the two enhanced images 112 and 113 for producing an enhanced stereo digital image.

Notice that the enhanced image 69 has demosaiced color values that are determined from at least two images 132 and 142. The color values of the enhanced image are considered to be corrected color values because the enhanced image contains at each pixel location, a color value for each of a set of color primaries instead of a single value associated with the color filter of the corresponding photosite. Note that the image processor 70 uses values of the second image based on the alignment between the first and second images to operate on the first digital image to produce the enhanced digital image having corrected color values. In the previous embodiment, the images 132 and 142 were originated from two different image sensors 130 and 140, each having a unique predetermined color pattern. The image sensors 130 and 140 can have many other different color patterns. For example, FIG. 7 shows a pair of image sensors 130 and 140 that have the same repeating color unit but a different predetermined color pattern. In this case, each repeating color unit has red, green, blue, and luminance colors, but the repeating color unit is shifted in phase (i.e. the starting point is different) on one image sensor relative to the other. When the image processor 70 produces the enhanced image 69 by the method illustrated in FIG. 11, there is still an advantage in the quality of the enhanced image by using pixel values from both the first and the second images from which to estimate the missing color values. This advantage is especially striking when the alignment warping function is applied to one image to align it to the first image, and the overlapping pixel locations are associated with photosites having different color filters.

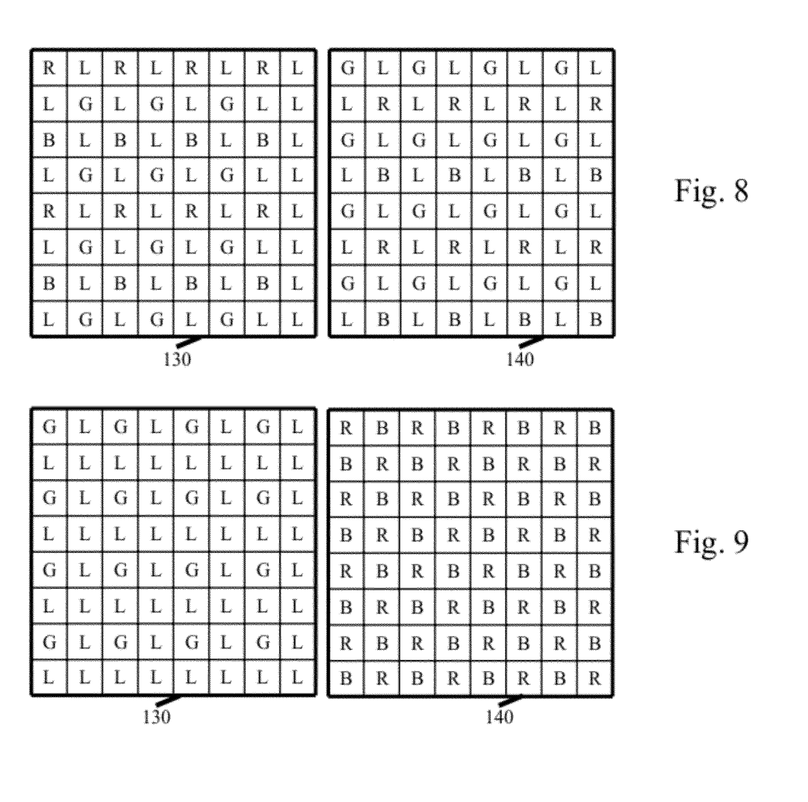

FIG. 8 shows the predetermined color filter patterns for two different image sensors 130 and 140, each having red, green, blue, and luminance color filters over photosites in proportions of 1:2:1:4, respectively. FIG. 9 shows the predetermined color filter patterns for two different image sensors 130 and 140 to illustrate that neither image sensor 130, 140 need have more than 2 colors to produce enhanced images 69 having at least 3 color values at each pixel location. In this example, the image sensor 130 has luminance and green photosites, and the image sensor 140 has blue and red photosites. In this case, the enhanced left image is found by determining missing red and blue color values at pixel locations in the left image that correspond to green color filters and determining missing green, red, and blue color values at pixel locations in the left image that correspond to luminance color filters. Likewise, the enhanced right image is found by determining missing green and blue color values at pixel locations in the right image that correspond to red color filters and determining missing green and red color values at pixel locations in the right image that correspond to a blue color filter.

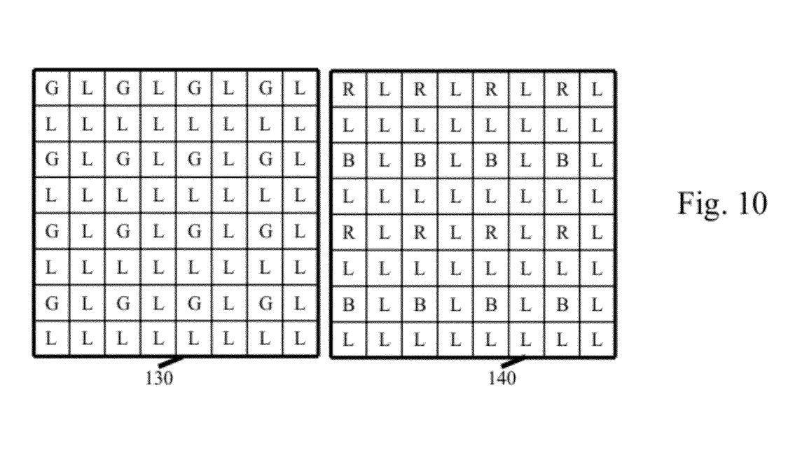

FIG. 10 shows yet another example of image sensors 130 and 140 where the first image sensor 130 contains a predetermined color pattern with green and luminance photosites, and the second image sensor 140 contains a predetermined color pattern with red, blue and luminance photosites.

When the color filters on an image sensor include red, green, and blue filters, they are generally referred to as primary color filters in the known art. When the color filters on an image sensor include cyan, magenta, and yellow, they are generally referred to as secondary color filters in the known art. The image sensors 130 and 140 can have predetermined color patterns corresponding to primary and secondary color filters respectively, for example, one of them is primary colors and the other secondary colors. The collection of unique different color filters associated with a predetermined color pattern placed over an image sensor is the set of color filters associated with that image sensor, for example, the Bayer filter pattern's set of color filters is red, green, and blue. The image sensors 130 and 140 can have different sets of color filters corresponding to different color patterns. For example, in FIG. 6, the first set of color filters is luminance and the second set of color filters is red, green, and blue and they are different from each other.

The invention has been described in detail with particular reference to certain preferred embodiments thereof, but it will be understood that variations and modifications can be effected within the spirit and scope of the invention.

### PARTS LIST

12 digital processor
30 image capture device
43 compass
45 tilt sensor
47 accelerometer
49 light source
60 user controls
62 user preferences
69 enhanced image
70 image processor
90 display
101 receive left image
102 receive right image
103 detect feature points in left image
104 detect feature points in right image
105 perform feature matching
106 identify high confidence feature matches
107 compute alignment warping function
111 correct color values
112 enhanced left image
113 enhanced right image
130 image capture device, image sensor
132 image or video
134 lens
140 image capture device, image sensor
142 image or video
144 lens
154 lens
162 pixel location
164 lens
212 vector indicating spatial relationship between feature points in left and right images
322 RAM
324 real time clock
328 firmware memory
329 GPS unit
340 audio coded
342 microphone
341 general control computer
344 speaker
350 wireless modem
358 mobile phone network
370 internet
375 image player

1. An image capture device for producing an enhanced digital image of a scene comprising:
(a) a lens arrangement having a first lens associated with a first digital image sensor and a second lens associated with a second digital image sensor; the first digital image sensor having photosites of a first predetermined color pattern for producing a first digital image of the scene; the second digital image sensor having photosites of a different second predetermined color pattern for producing a second digital image of the scene;
(b) a device for causing the lens arrangement to capture a first digital image from the first digital image sensor and a second digital image from the second digital image sensor at substantially the same time;
(c) a processor for aligning the first and second digital images; and
(d) the processor using values of the second image based on the alignment between the first and second images to operate on the first digital image to produce the enhanced digital image having corrected color values.

2. The image capture device of claim 1, wherein the lens arrangement is a stereo lens arrangement and the processor uses the enhanced digital image and the second digital image, or an enhanced version thereof, for producing an enhanced stereo digital image.

3. The image capture device of claim 1, wherein the first and second digital image sensors have color filters placed over the photosites of the first and second digital image sensors, and wherein the first digital image sensor has a photosite with a color filter that is different from all the color filters on the second digital image sensor.

4. The image capture device of claim 3, wherein the first digital image sensor has luminance photosites and the second digital image sensor has red, green, and blue photosites.

5. The image capture device of claim 1, wherein the first digital image sensor has a predetermined color pattern including primary colors and the second digital image sensor has a predetermined color pattern including secondary colors.

6. The image capture device of claim 1, wherein the first and second digital image sensors have predetermined color patterns with red, green, blue, and luminance colors.

7. The image capture device of claim 1, wherein the first and second digital image sensors have predetermined color patterns with the same set of colors.

8. The image capture device of claim 1, wherein the first digital image sensor has green and luminance photosites and the second digital image sensor has red and blue photosites.

9. The image capture device of claim 1, wherein the first digital image sensor has green and luminance photosites and the second digital image sensor has red, blue, and luminance photosites.
